(19) United States
(12) Patent Application Publication
(10) Pub. No.: US 2014/0053100 A1
(43) Pub. Date: Feb. 20, 2014

(54) Data Displaying Method and Apparatus

(71) Applicant: TENCENT TECHNOLOGY (SHENZHEN) COMPANY LIMITED, Shenzhen (CN)

(72) Inventors: Meng Zhou, Shenzhen (CN); Jia Yu, Shenzhen (CN); Chunshan Su, Shenzhen (CN); Zhan Chen, Shenzhen (CN)

(73) Assignee: TENCENT TECHNOLOGY (SHENZHEN) COMPANY LIMITED, Shenzhen (CN)

(21) Appl. No.: 14/064,249

(22) Filed: Oct. 28, 2013

Related U.S. Application Data
(63) Continuation of application No. PCT/CN2012/073522, filed on May 4, 2012.

(30) Foreign Application Priority Data
Apr. 28, 2011 (CN) 201110108440.5

(51) Int. Cl. G06F 3/0484; G06F 3/0488

(52) U.S. Cl. CPC G06F 3/04842; G06F 3/0488
USPC 715/790

(57) ABSTRACT

A data displaying method and apparatus is disclosed. The method includes: obtaining a touch action coordinate triggered in a displaying page by a user; intercepting a first region from the displaying page, wherein the center of the first region is the touch action coordinate and the size of the first region is a predefined value that is determined by the size of a magnifier to be drawn; magnifying the first region, and taking the magnified first region as a brush pattern, wherein the magnification of the first region is determined by the magnification of the magnifier; and calculating a second region for drawing the magnifier in the displaying page, and drawing and displaying the magnifier in the second region by using the brush pattern. By the method and apparatus, a magnifier function can be realized on a Symbian platform, and the user can accurately select wanted characters.

### CROSS-REFERENCES TO RELATED APPLICATIONS

This application is a continuation of International Application No. PCT/CN2012/073522, filed on Apr. 5, 2012, which claims priority to Chinese patent application No. 201110108440.5, filed on Apr. 28, 2011, the content of which are incorporated herein by reference in their entirety.

### FIELD OF THE INVENTION

The present invention relates to computer technologies, and more particularly to a data displaying method and apparatus.

### BACKGROUND OF THE INVENTION

Because the screen of mobile phone is small, it is difficult for a user to accurately select wanted characters from a large number of characters displayed on the screen. For example, when the user selects the wanted characters through the touch of a finger, unwanted characters may be selected because the finger obscures a selected region.

In order to guarantee the accuracy of character selection, a magnifier function is provided in the prior art. The magnifier function refers to intercepting a region from a page displayed on the screen of mobile phone, where the center of the intercepted region is a coordinate of touch down action of the user on the screen and the radius of the intercepted region is a predefined value, magnifying the region, placing the magnified region in a newly created round region, and displaying the round region above the coordinate of touch down action in the page. In this way, the user can clearly see the wanted characters in the displayed round region and accurately select the characters.

At present, Symbian platform is widely applied because of following advantages. The general technology of mobile device, that is, the core of operation system, is separated from graphical user interface technology, so as to adapt to platforms with different input modes, allow a manufacturer manufacturing a more friendly operation interface for its product, and meet personality requirements. However, the Symbian platform has no magnifier function, and thus cannot guarantee that the user accurately selects and displays the wanted characters.

Accordingly, it is needed to provide a method for accurately selecting and displaying characters by using a magnifier on the Symbian platform.

### SUMMARY OF THE INVENTION

Examples of the present invention provide a data displaying method and apparatus, so as to realize a magnifier function on a Symbian platform, and further guarantee that a user can accurately select wanted characters.

The solution provided by the examples of the present invention includes following contents.

A data displaying method includes:
obtaining a touch action coordinate triggered in a displaying page by a user;
intercepting a first region from the displaying page, wherein the center of the first region is the touch action coordinate and the size of the first region is a predefined value that is determined by the size of a magnifier to be drawn;
magnifying the first region, and taking the magnified first region as a brush pattern, wherein the magnification of the first region is determined by the magnification of the magnifier; and
calculating a second region for drawing the magnifier in the displaying page, and drawing and displaying the magnifier in the second region by using the brush pattern.

A data displaying apparatus includes:
one or more processors;
memory; and
one or more units stored in the memory and to be executed by the one or more processors, the one or more units including:
an obtaining unit, configured to obtain a touch action coordinate triggered in a displaying page by a user;
an intercepting unit, configured to intercept a first region from the displaying page, wherein the center of the first region is the touch action coordinate and the size of the first region is a predefined value that is determined by the size of a magnifier to be drawn;
a magnifying unit, configured to magnify the first region, and take the magnified first region as a brush pattern, wherein the magnification of the first region is determined by the magnification of the magnifier;
a calculating unit, configured to calculate a second region for drawing the magnifier in the displaying page; and
a drawing unit, configured to draw and display the magnifier by using the brush pattern in the second region.

A mobile terminal device for data displaying includes the above data displaying apparatus, where the data displaying apparatus includes:
one or more processors;
memory; and
one or more units stored in the memory and to be executed by the one or more processors, the one or more units including:
an obtaining unit, configured to obtain a touch action coordinate triggered in a displaying page by a user;
an intercepting unit, configured to intercept a first region from the displaying page, wherein the center of the first region is the touch action coordinate and the size of the first region is a predefined value that is determined by the size of a magnifier to be drawn;
a magnifying unit, configured to magnify the first region, and take the magnified first region as a brush pattern, wherein the magnification of the first region is determined by the magnification of the magnifier;
a calculating unit, configured to calculate a second region for drawing the magnifier in the displaying page; and
a drawing unit, configured to draw and display the magnifier by using the brush pattern in the second region.

As can be seen from the above solution provided by the examples of the present invention, the touch action coordinate triggered in the displaying page by the user is obtained, and the first region is intercepted from the displaying page, where the center of the first region is the touch action coordinate and the size of the first region is a predefined value; the first region is magnified, and the magnified first region is taken as the brush pattern; the second region for drawing the magnifier is calculated in the displaying page, and the magnifier is drawn and displayed in the second region by using the brush pattern. In this way, the magnifier function on the Symbian platform can be realized, and the user can accurately select wanted data such as characters.

### BRIEF DESCRIPTION OF THE DRAWINGS

FIG. 1 is a schematic flowchart illustrating a data displaying method according to an example of the present invention.

FIG. 2 is a schematic diagram illustrating a data displaying apparatus according to an example of the present invention.

FIG. 3 is a schematic diagram illustrating a data displaying apparatus according to another example of the present invention.

### DETAILED DESCRIPTION OF THE INVENTION

In a data displaying method provided by an example of the present invention, data may be characters or pictures in a page, which are not limited in the present invention. In order to make the solution of the present invention clearer, the examples of the present invention are described by taking characters as an example.

In order to make the object, technical solution and merits of the present invention clearer, the present invention will be illustrated in detail hereinafter with reference to the accompanying drawings and specific examples.

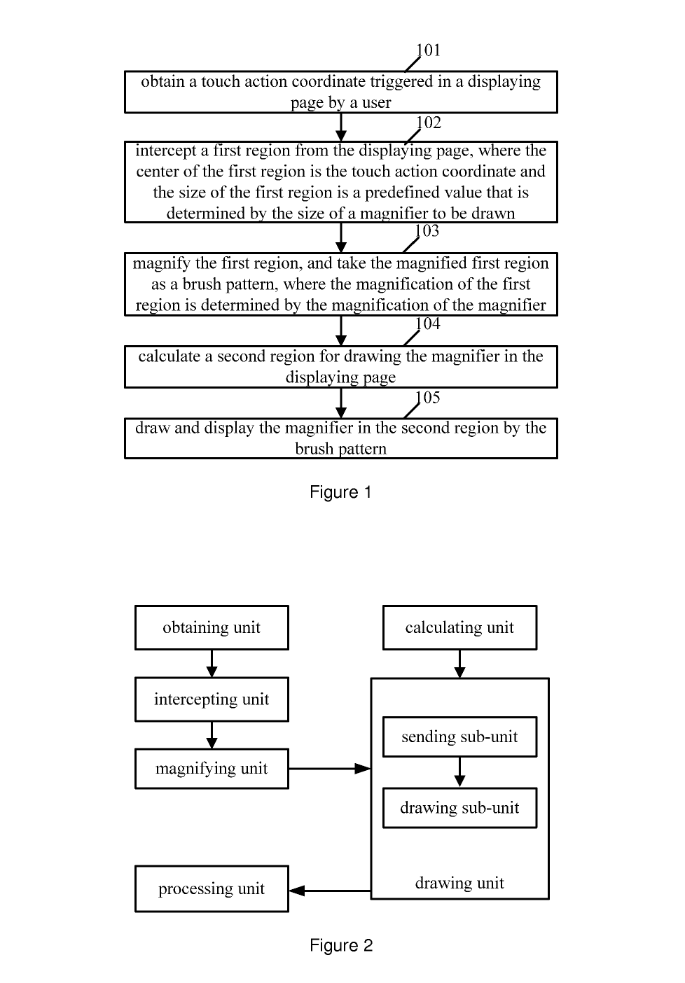

FIG. 1 is a schematic flowchart illustrating a data displaying method according to an example of the present invention. As shown in FIG. 1, the method includes following blocks.

In block 101, obtain a touch action coordinate triggered in a displaying page by a user.

In block 101, the touch action coordinate is a coordinate of touch down action of a user on a screen, or a coordinate of touch move action of the user on the screen.

It should be noted that, the method provided by the example may be applied to a Symbian-based mobile phone. Before block 101 is performed, the user first starts a freely copying function configured in the browser of the mobile phone, and then a region obtained by the touch down action or touch move action of the user on the screen is a character region selected by the user.

The freely copying function configured in the browser of the mobile phone is usually convenient for copying characters in a webpage opened on the browser of the mobile phone, so as to paste, search for or share the characters.

In block 102, intercept a first region from the displaying page, where the center of the first region is the touch action coordinate and the size of the first region is a predefined value that is determined by the size of a magnifier to be drawn.

For example, if the first region is a square region, the region of the magnifier is a round region, and the size S1 of the magnifier is equal to the area of the round region, i.e., S1=πr², where r is a radius of the round region, the size S2 of the square region is determined by S1, i.e., S2=4S1/π=4r².

In block 103, magnify the first region, and take the magnified first region as a brush pattern, where the magnification of the first region is determined by the magnification of the magnifier.

In this example, the magnifier usually has one magnification. In another example of the present invention, multiple magnifications may be configured for the magnifier. Based on this, the magnification in block 103 may be one of the multiple magnifications.

In block 103, the process of taking the magnified first region as the brush pattern includes: intercepting a third region from the magnified first region, where the center of the third region is the touch action coordinate and the size of the third region is the same as the size of the first region before magnification, and taking the third region as the brush pattern. As can be seen from block 103, a part of the magnified first region is taken as the brush pattern rather than take the whole magnified first region as the brush pattern, which can more accurately display the characters selected by the user.

In block 104, calculate a second region for drawing the magnifier in the displaying page.

Block 104 includes: determining a location around (such as above, below and so on, which is not limited in the example of the present invention) the touch action coordinate, where a distance between the location and the touch action coordinate is a predefined value; taking a region in the displaying page as the second region, where the center of the region is the determined location and the size of the region is the same as the size of the magnifier. The predefined value may be any value as long as the second region can be displayed entirely, which is not limited in the example of the present invention.

In block 105, draw and display the magnifier in the second region by the brush pattern.

Block 105 includes: sending parameters including the coordinate of the center of the second region and the size of the second region to a drawing function for drawing the magnifier on a Symbian platform, e.g., DrawRoundRect( ); filling, by the drawing function, the second region by using the parameters and the brush pattern, and drawing a rim of the magnifier at the edge of the second region.

The process of drawing the rim of the magnifier at the edge of the second region includes: calling a bitmap function on the Symbian platform by using a drawing handle on the Symbian, e.g., a DrawBitmap function, and drawing the rim of the magnifier at the edge of the second region by the bitmap function.

And thus, the flowchart shown in FIG. 1 terminates.

In the above flowchart, as an example of the present invention, the first region is a square region, the second region is a round region, and thus the side of the square region is equal to the diameter of the round region.

It should be noted that, in the example of the present invention, after the magnifier is drawn, if the user performs a touch up action from the screen for the drawn magnifier, for example, performs a touch down action on the screen again after the current touch down action on the screen or moves from the current location to a next location, the magnifier corresponding to the current touch down action on the screen or the current location is cancelled. That is, the magnifier corresponding to the current touch down action on the screen or the current location disappears.

In addition, as can be seen from the flowchart shown in FIG. 1, in a scene of touch move action of the user on the screen, every location (coordinate) is passed, a magnifier is drawn and displayed, which looks like that the magnifier moves with the change of the location (coordinate) for the user.

The forgoing describes the method provided by the example of the present invention, and an apparatus provided by an example of the present invention is illustrated hereinafter.

FIG. 2 is a schematic diagram illustrating a data displaying apparatus according to an example of the present invention. As shown in FIG. 2, the apparatus includes an obtaining unit, an intercepting unit, a magnifying unit, a calculating unit and a drawing unit.

The obtaining unit is configured to obtain a touch action coordinate triggered in a displaying page by a user, where the touch action coordinate is a coordinate of touch down action of the user on a screen, or a coordinate of touch move action of the user on the screen.

The intercepting unit is configured to intercept a first region from the displaying page, where the center of the first region is the touch action coordinate and the size of the first region is a predefined value that is determined by the size of a magnifier to be drawn. For example, if the first region is a square region, the region of the magnifier is a round region, and the size S1 of the magnifier is equal to the area of the round region, i.e., S1=πr², where r is a radius of the round region, the size S2 of the square region is determined by S1, i.e., S2=4S1/π=4r².

The magnifying unit is, configured to magnify the first region, and take the magnified first region as a brush pattern, where the magnification of the first region is determined by the magnification of the magnifier.

The calculating unit is configured to calculate a second region for drawing the magnifier in the displaying page.

The drawing unit is configured to draw and display the magnifier by using the brush pattern in the second region.

In this example, when the calculating unit calculate the second region, the calculating unit is configured to determine a location around the touch action coordinate, where a distance between the location and the touch action coordinate is a predefined value, and take a region in the displaying page as the second region, where the center of the region is the determined location and the size of the region is the same as the size of the magnifier.

When the magnifying unit takes the magnified first region as the brush pattern, the magnifying unit is configured to intercept a third region from the magnified first region, where the center of the third region is the touch action coordinate and the size of the third region is the same as the size of the first region before magnification, and take the third region as the brush pattern.

As shown in FIG. 2, the drawing unit includes:
a sending sub-unit, configured to send parameters including the coordinate of the center of the second region and the size of the second region to a drawing function for drawing the magnifier on a Symbian platform, where the drawing function fills the second region by using the parameters and the brush pattern; and
a drawing sub-unit, configured to draw a rim of the magnifier at the edge of the second region after the filling process.

In this example, as shown in FIG. 2, the apparatus further includes:
a processing unit, configured to cancel the drawn magnifier when the user performs a touch up action from the screen for the drawn magnifier.

The foregoing has described the apparatus shown in FIG. 2.

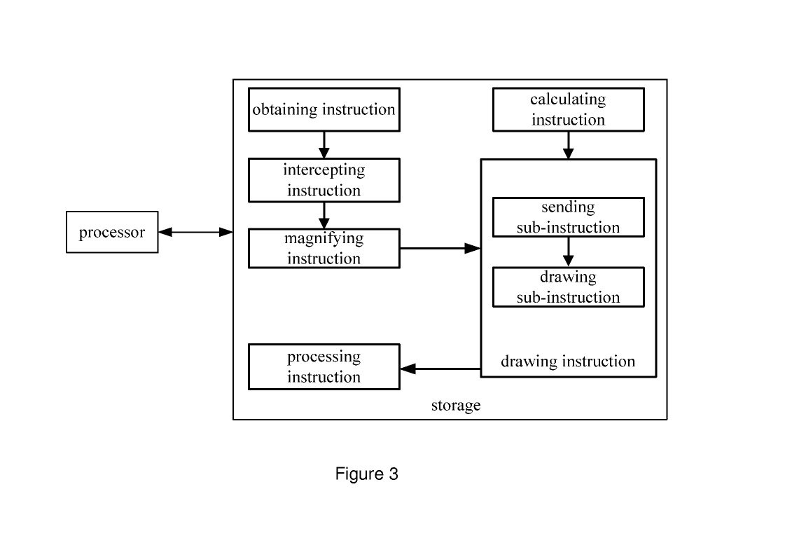

FIG. 3 is a schematic diagram illustrating a data displaying apparatus according to another example of the present invention. As shown in FIG. 3, the data displaying apparatus at least includes storage and a processor communicated with the storage. The storage includes an obtaining instruction, an intercepting instruction, a magnifying instruction, a calculating instruction and a drawing instruction which can be executed by the processor.

The obtaining instruction is configured to obtain a touch action coordinate triggered in a displaying page by a user.

The intercepting instruction is configured to intercept a first region from the displaying page, where the center of the first region is the touch action coordinate and the size of the first region is a predefined value that is determined by the size of a magnifier to be drawn.

The magnifying instruction is configured to magnify the first region, and take the magnified first region as a brush pattern, where the magnification of the first region is determined by the magnification of the magnifier.

The calculating instruction is configured to calculate a second region for drawing the magnifier in the displaying page.

The drawing instruction is configured to draw and display the magnifier by using the brush pattern in the second region.

Preferably, the calculating instruction is configured to determine a location around the touch action coordinate, where a distance between the location and the touch action coordinate is a predefined value, and take a region in the displaying page as the second region, where the center of the region is the determined location and the size of the region is the same as the size of the magnifier.

Preferably, the magnifying instruction is configured to intercept a third region from the magnified first region, where the center of the third region is the touch action coordinate and the size of the third region is the same as the size of the first region before magnification, and take the third region as the brush pattern.

Preferably, the drawing instruction includes:
a sending sub-instruction, configured to send parameters including the coordinate of the center of the second region and the size of the second region to a drawing function for drawing the magnifier on a Symbian platform, where the drawing function fills the second region by using the parameters and the brush pattern; and
a drawing sub-instruction, configured to draw a rim of the magnifier at the edge of the second region after the filling.
Preferably, the apparatus further includes:
a processing instruction, configured to cancel the drawn magnifier when the user performs a touch up action from a screen for the drawn magnifier.

An example of the present invention also provides a mobile terminal device for data displaying. The mobile terminal device may be a mobile phone, which includes the apparatus shown in FIG. 2.

As can be seen from the above solution provided by the examples of the present invention, the touch action coordinate triggered in the displaying page by the user is obtained, and the first region is intercepted from the displaying page, where the center of the first region is the touch action coordinate and the size of the first region is a predefined value; the first region is magnified, and the magnified first region is taken as the brush pattern; the second region for drawing the magnifier is calculated in the displaying page, and the magnifier is drawn and displayed in the second region by using the brush pattern. In this way, the magnifier function on the Symbian platform can be realized, and the user can accurately select wanted data such as characters.

Further, in the examples of the present invention, the characters are displayed through the magnifier, and the user may adjust the selected characters according to the displayed characters, which improves the accuracy of character selection and decreases error operations.

Further, in the examples of the present invention, a part of the magnified first region is taken as the brush pattern rather than take the whole magnified first region as the brush pattern, which can more accurately display the characters selected by the user.

The foregoing is only preferred examples of the present invention and is not used to limit the protection scope of the present invention. Any modification, equivalent substitution and improvement without departing from the spirit and principle of the present invention are within the protection scope of the present invention.

What is claimed is:

1. A data displaying method, comprising:
obtaining a touch action coordinate triggered in a displaying page by a user;
intercepting a first region from the displaying page, wherein the center of the first region is the touch action coordinate and the size of the first region is a predefined value that is determined by the size of a magnifier to be drawn;
magnifying the first region, and taking the magnified first region as a brush pattern, wherein the magnification of the first region is determined by the magnification of the magnifier; and
calculating a second region for drawing the magnifier in the displaying page, and drawing and displaying the magnifier in the second region by using the brush pattern.

2. The method of claim 1, wherein the touch action coordinate is a coordinate of touch down action of a user on a screen, or a coordinate of touch move action of the user on the screen.

3. The method of claim 1, wherein the calculating the second region for drawing the magnifier in the displaying page comprises:
determining a location around the touch action coordinate, wherein a distance between the location and the touch action coordinate is a predefined value; and
taking a region in the displaying page as the second region, wherein the center of the region is the determined location and the size of the region is the same as the size of the magnifier.

4. The method of claim 1, wherein the taking the magnified first region as the brush pattern comprises:
intercepting a third region from the magnified first region, wherein the center of the third region is the touch action coordinate and the size of the third region is the same as the size of the first region before magnification; and
taking the third region as the brush pattern.

5. The method of claim 1, wherein the drawing the magnifier by using the brush pattern in the second region comprises:
sending parameters including the coordinate of the center of the second region and the size of the second region to a drawing function for drawing the magnifier on a Symbian platform;
filling, by the drawing function, the second region by using the parameters and the brush pattern; and
drawing a rim of the magnifier at the edge of the second region after the filling.

6. The method of claim 1, wherein the method applied to a mobile terminal device; and
the touch action coordinate triggered in the displaying page by the user is obtained after a freely copying function configured in the browser of the mobile terminal device is started.

7. The method of claim 1, after drawing the magnifier, further comprising:
cancelling the drawn magnifier when the user performs a touch up action from the screen for the drawn magnifier.

8. The method of claim 1, wherein the first region is a square region and the second region is a round region; and
the side of the square region is equal to the diameter of the round region.

9. A data displaying apparatus, comprising:
one or more processors;
memory; and
one or more units stored in the memory and to be executed by the one or more processors, the one or more units including:
an obtaining unit, configured to obtain a touch action coordinate triggered in a displaying page by a user;
an intercepting unit, configured to intercept a first region from the displaying page, wherein the center of the first region is the touch action coordinate and the size of the first region is a predefined value that is determined by the size of a magnifier to be drawn;
a magnifying unit, configured to magnify the first region, and take the magnified first region as a brush pattern, wherein the magnification of the first region is determined by the magnification of the magnifier;
a calculating unit, configured to calculate a second region for drawing the magnifier in the displaying page; and
a drawing unit, configured to draw and display the magnifier by using the brush pattern in the second region.

10. The apparatus of claim 9, wherein the calculating unit is configured to determine a location around the touch action coordinate, wherein a distance between the location and the touch action coordinate is a predefined value, and take a region in the displaying page as the second region, wherein the center of the region is the determined location and the size of the region is the same as the size of the magnifier.

11. The apparatus of claim 9, wherein the magnifying unit is configured to intercept a third region from the magnified first region, wherein the center of the third region is the touch action coordinate and the size of the third region is the same as the size of the first region before magnification, and take the third region as the brush pattern.

12. The apparatus of claim 9, wherein the drawing unit comprises:
a sending sub-unit, configured to send parameters including the coordinate of the center of the second region and the size of the second region to a drawing function for drawing the magnifier on a Symbian platform, wherein the drawing function fills the second region by using the parameters and the brush pattern; and
a drawing sub-unit, configured to draw a rim of the magnifier at the edge of the second region after the filling.

13. The apparatus of claim 9, further comprising:
a processing unit, configured to cancel the drawn magnifier when the user performs a touch up action from a screen for the drawn magnifier.

14. A mobile terminal device for data displaying, comprising a data displaying apparatus, wherein the data displaying apparatus comprises:
one or more processors;
memory; and
one or more units stored in the memory and to be executed by the one or more processors, the one or more units including:
an obtaining unit, configured to obtain a touch action coordinate triggered in a displaying page by a user;
an intercepting unit, configured to intercept a first region from the displaying page, wherein the center of the first region is the touch action coordinate and the size of the first region is a predefined value that is determined by the size of a magnifier to be drawn;
a magnifying unit, configured to magnify the first region, and take the magnified first region as a brush pattern, wherein the magnification of the first region is determined by the magnification of the magnifier;
a calculating unit, configured to calculate a second region for drawing the magnifier in the displaying page; and
a drawing unit, configured to draw and display the magnifier by using the brush pattern in the second region.
